(19) United States
(12) Patent Application Publication
(10) Pub. No.: US 2023/0033957 A1
(43) Pub. Date: Feb. 2, 2023

(54) METHODS AND SYSTEMS FOR IMPLEMENTING WATERFALL GATEWAYS

(71) Applicant: Synchrony Bank, Stamford, CT (US)

(72) Inventors: Joydeep Mukherjee, Stamford, CT (US); Karen Yagnesak, Stamford, CT (US); Viveka Vardhan Ravi, Stamford, CT (US); Sarath Vadakapurapu, Stamford, CT (US); Ravish Kumar, Stamford, CT (US); Vish Dadireddy, Stamford, CT (US)

(21) Appl. No.: 17/815,416

(22) Filed: Jul. 27, 2022

Related U.S. Application Data
(60) Provisional application No. 63/203,661, filed on Jul. 27, 2021.

(51) Int. Cl. H04L 69/40; G06F 9/50; H04L 67/142

(52) U.S. Cl. CPC H04L 69/40; G06F 9/5027; H04L 67/142

(57) ABSTRACT

Systems and method are provided for providing a waterfall gateway configured to enable communication between disparate devices. The waterfall gateway receives an indication that a first resource request was denied by a server. In response, the waterfall gateway identifies two or more client devices configured to provide services to the user. The waterfall gateway generates a resource request waterfall that includes a sequence of client devices of the two or more client devices. The resource request waterfall is configured to facilitate resource request transmissions to the one or more client devices according to the sequence of client devices. The waterfall gateway facilitates a transmission of a second resource request to a first client device in the sequence of client devices.

### CROSS REFERENCE TO RELATED APPLICATIONS

This application claims benefit to U.S. Provisional Patent Application No. 63/203,661 filed on Jul. 27, 2021, which is hereby incorporated by reference in its entirety for all purposes.

### TECHNICAL FIELD

This disclosure generally relates to a network interface between disparate systems; and more specifically to a waterfall gateway that abstracts calls between an internal network and one or more external networks.

### BACKGROUND

Networks operated by a same service provider may use a predetermined and therefore known communication protocol. Similarly, the syntax and protocols of functional calls and/or remote procedure calls (RPCs) may also be known to devices operated by the service provider. A first system can readily communicate with a second system associated with the service provider by transmitting communications and/or executing instructions that correspond to the expected communication protocol or syntax. Devices of external networks (e.g., such as those operated by a different service provider) may use different communication protocols. Communicating with these devices may require each device to know the communication protocols supported by the other device or have the capability to translate messages in one communication protocol to another communication protocol. Devices that cannot communicate over a common communication protocol or translate communications into native communication protocols may be prevented from communicating, which may render critical functionality of either system inoperable. Such difficulties may be exasperated when operations involve multiple disparate networks and/or service providers.

### SUMMARY

Methods and systems are described herein for generating waterfall gateways. The methods include receiving an indication that a first resource request was denied by a server, the indication including a user identifier; identifying, using the user identifier, two or more client devices configured to provide services to the user; generating a resource request waterfall that includes a sequence of client devices of the two or more client devices, wherein the resource request waterfall is configured to facilitate resource request transmissions to the one or more client devices according to the sequence of client devices; and facilitating a transmission of a second resource request to a first client device in the sequence of client devices.

Systems are described herein for generating waterfall gateways. The systems include one or more processors and a non-transitory computer-readable medium storing instructions that, when executed by the one or more processors, cause the one or more processors to perform any of the methods as previously described.

Non-transitory computer-readable media are described herein for storing instructions that, when executed by the one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A illustrates an example system that can be used with custom resource allocations according to aspects of the present disclosure.

FIG. 1B illustrates aspects of a system that can be used with custom resource allocations according to aspects of the present disclosure.

FIG. 2 illustrates an example block diagram representing a waterfall gateway according to aspects of the present disclosure.

FIG. 3 illustrates an example block diagram representing the establishment of communications between a client device and a user device through a waterfall gateway according to aspects of the present disclosure.

FIG. 4 illustrates an example block diagram representing a waterfall gateway that establishes communications between a client device and a user device according to aspects of the present disclosure.

FIG. 5 illustrates a flowchart of an example execution of the waterfall gateway according to aspects of the present disclosure.

FIG. 6 illustrates a flowchart of an example account lookup process executing within the waterfall gateway according to aspects of the present disclosure.

FIG. 7 illustrates a flowchart of an example object acquisition process executing within the waterfall gateway according to aspects of the present disclosure.

FIG. 8 illustrates flowchart of an example execution of the waterfall gateway according to aspects of the present disclosure.

FIG. 9 shows a computing system architecture including various components in electrical communication with each other using a connection according to aspects of the present disclosure.

### DETAILED DESCRIPTION

The present disclosure includes systems and methods for implementing a gateway waterfall that enables communications between devices of a first architecture and devices of multiple disparate architectures. Devices operated by a same service provider may communicate using one or more predetermined communication protocols. Since the communication protocols are predetermined, the transmitting device and the receiving device can parse the communication according to the known protocols. Communicating with external devices (e.g., devices operated by a different service provider) may be difficult. Without a common communication protocol, a receiving device may not be capable of parsing incoming communications. The waterfall gateway described herein includes a central interface positioned between devices operated by a firsts service provider (e.g., internal devices) and devices operated by multiple, different service providers (e.g., external devices, each potentially operating using a different communication protocol). The waterfall gateway abstracts communications received from the internal devices and external devices and provides those communications to the receiving device in the native communication protocol of the receiving device.

The waterfall gateway may be usable by users interacting with an internal device for requesting an object, a resource request, and/or to establish an acquisition protocol. The internal device may include devices and/or services for requestion and/or satisfying resource requests, defining acquisition protocols for object or resource requests, implementing acquisition protocols for resource requests, determining if pre-approval criteria are met for a user, acquiring objects for the user, and/or the like. In some instances, the internal device may deny a request by the user interacting with the internal device. For example, the user may fail to meet predetermined criteria, the internal device may lack the resources to satisfy the request, etc. In response, the internal device may transmit a request to the waterfall gateway. The internal device and the waterfall gateway may communicate according to a common communication protocol such as one implemented over a representational state transfer (RESTful) architecture.

The waterfall gateway receives the request and generates a resource-request waterfall that is configured to transmit the user's resource request to a sequence of devices (each potentially being operated by a different service provider and/or the first service provider). The waterfall gateway then executes the resource-request waterfall by transmitting the request to the first device in the sequence of devices and waiting for a response. If the first device denies the resource request and/or fails to response within a predetermined time interval, the waterfall gateway transmits the user's request to the next device in the sequence. This process continues until a device approves the resource request or there the waterfall gateway transmits the request to each of the devices of the sequence and there are no additional devices to receive the user's request.

For each transmission to a device in the sequence, the waterfall gateway determines a communication protocol that is native to the receiving device. In some instances, the waterfall gateway determines the native communication protocol by inspecting the receiving device (e.g., inspecting data packets received from the device, inspecting a network of the device, etc.) and/or communications received from the receiving device. In one example, the waterfall gateway may publish a default messaging scheme that includes generic data. The receiving device may transmit a communication that includes the generic data in the native communication protocol. Since the payload (e.g., the generic data) of the communication is known to the waterfall gateway, the waterfall gateway may determine how to transmit communications in the native communication protocol of the receiving device. For example, the waterfall gateway may analyze the structure of the communication using artificial intelligence and/or a statistical classifier to determine how to transmit other communications structured in a similar or same manner so as to be parsable by the receiving device. The waterfall gateway may then transmit communications to the receiving device in the native communication protocol of the receiving device. In other instances, the device may register with the waterfall gateway before the waterfall gateway transmits communications to the receiving device. The receiving device may provide an identification of the receiving device, an identification of a service provider of the receiving device, an identification of other devices operated by the same service provider of the receiving device, an identification of a native communication protocol of the receiving device and/or the service provider of the receiving device, application programming interface configured to translate communications into the native communication protocol, combinations thereof, or the like.

When a receiving device in the sequence of devices approves the resource request, the user may be directed to input additional information to enable the receiving device to satisfy the resource request. In some instances, the user may interact directly with the receiving device (e.g., through a web-based interface, a web service, a native application, or the like). In other instances, the user may interact with the waterfall gateway and the waterfall gateway may communicate with the receiving device. For example, if the user cannot communicate with the receiving device using the native communication protocol of the receiving device (or otherwise finds it difficult to communicate with the receiving device), the waterfall gateway may use the cross-protocol and cross-platform communication capabilities to enable such communications. As a result, the user need not determine how to establish communications with the receiving device or adapt communications in the native communications protocol.

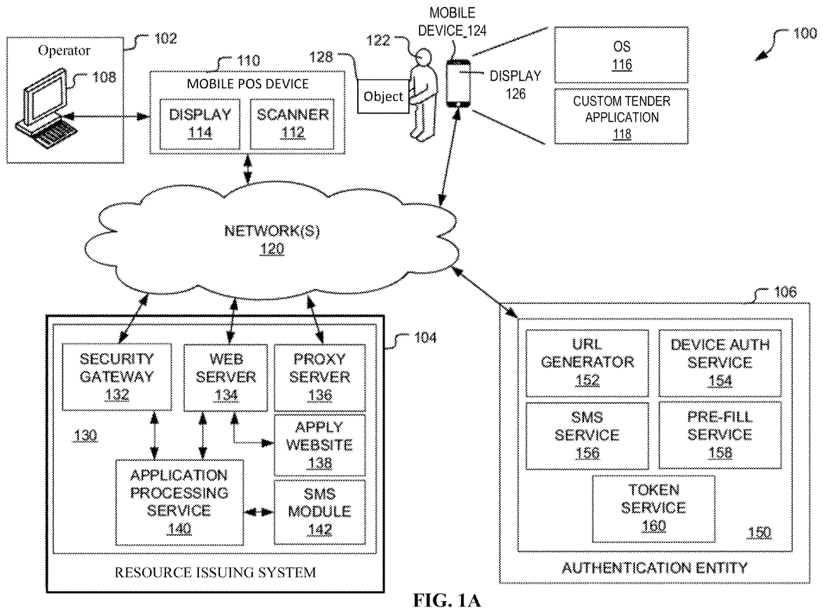

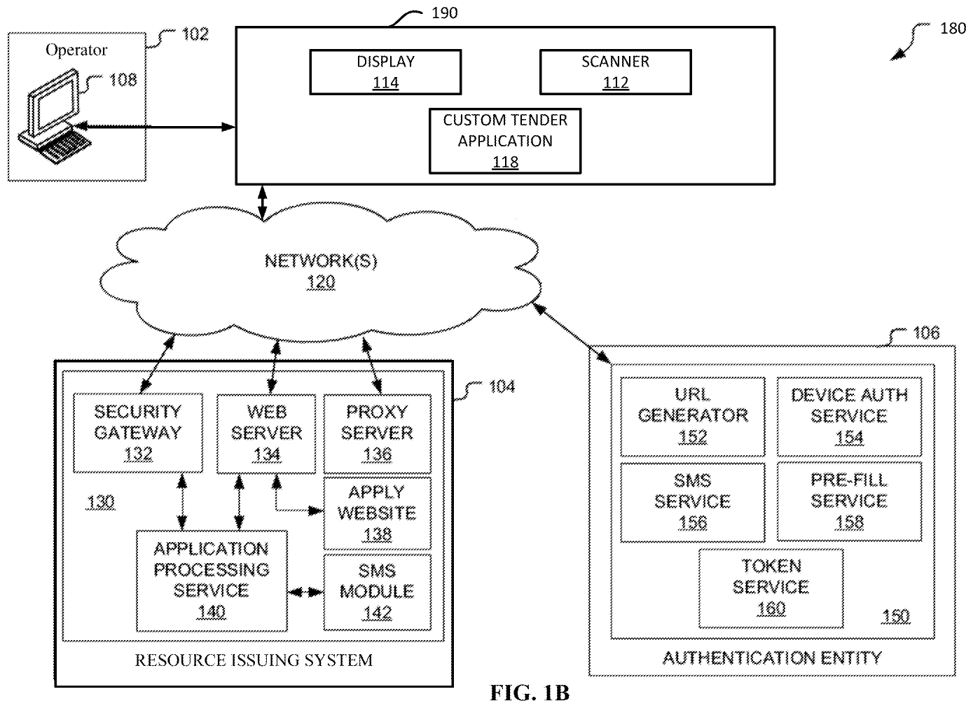

FIG. 1A illustrates an example system that can be used with custom resource allocations according to aspects of the present disclosure. In example system 100 of FIG. 1A, POS device 110 can include a user interface element for a custom tender option as described above. The custom tender option can be presented as a user 122 is purchasing an object 128. When the custom tender option is selected on POS device 110, POS device 110 can communicate with custom tender application 118 on mobile device 124 of user 122. Additional aspects of such systems and operations of a custom tender application 118 are described below.

The example system 100 includes an operator 102 (e.g., such as a retailer, datastore, etc.), a resource issuing system 104, and an authentication entity 106. In some systems, aspects can be merged, such as for example, the authenticating entity 106 being merged with the resource issuing system 104 such that devices of entity 106 and system 104 can be the same device or devices. The operator 102 (e.g., a merchant or other client of authentication entity 106) includes an operator computing system 108 connected to at least one POS device 110. The illustrated POS device 110 includes a scanner 112 (e.g., a barcode scanner) and a display device 114. The POS device 110 of FIG. A1 can include various systems for communicating with mobile device 124. The communication systems can include Bluetooth, WiFi, or other wireless network systems for communication. In some examples, rather than communicating using local wireless communications, a code or other matching mechanism can be used to match custom tender application 118 with POS device 110 via a wide area network (e.g., the Internet) to allow communications and dynamic synchronization between POS device 110 and mobile device 124. In various implementations, the user device 124 can access various communication channels, including short message service (SMS), text, application-based communications, e-mail, web browsers, or other such communication channels.

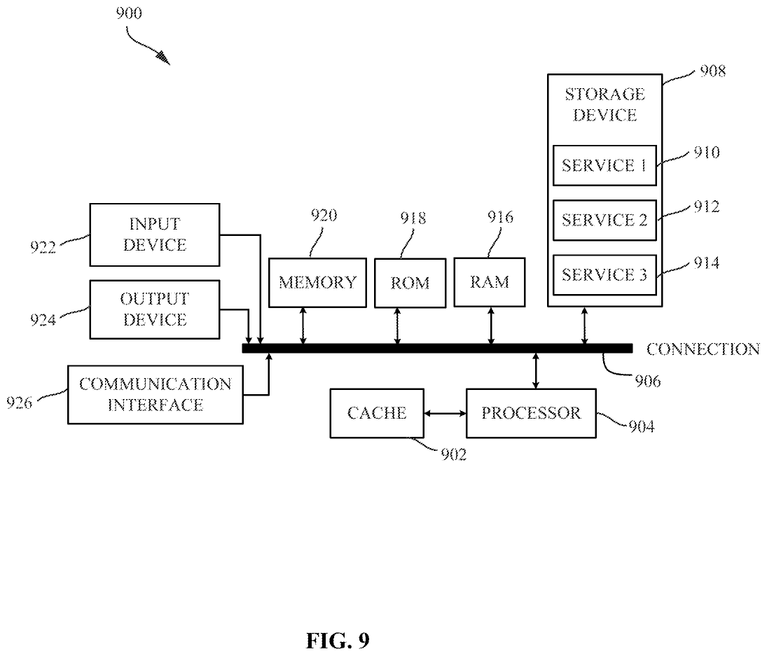

Once a connection is established between POS device 110 and mobile device 124, custom tender operations can be performed using custom tender application 118 as described below. Additionally, other implementations of POS device 110 can include a resource scanner or other payment input, a keypad, or other such elements. Additional examples of a POS device 110 can be a tablet device, a smartphone, a laptop computer, or any other such device that can be accessed by a user, either directly, or through an employee of the operator. The operator computing system 108 may be directly connected or connected by one or more networks 120 (described below) to the POS device 110. The operator computing system 108 and the POS device 110 may each be implemented by one or more computing devices, which may each be implemented as a computing device with architecture 900 described below and illustrated in FIG. 9.

Referring to FIG. 1A, the POS device 110 is configured to be operated by a user 122 having a user device 124 (e.g., a cellular telephone) with a display device 126 (e.g., a conventional touch screen). For example, the user 122 may acquire one or more object 128 using the POS device 110. As will be described below, the user 122 may also use the POS device 110 and the mobile device 124 to apply for resources (e.g., credit).

Referring to FIG. 1A, mobile services are provided to the mobile device 124 by a mobile service provider or carrier 170. The carrier 170 operates one or more computing devices 172 configured to communicate over the network(s) 120. The computing device(s) 172 may each be implemented as the computing device with architecture 900 described below and illustrated in FIG. 9.

The resource issuing system 104 operates one or more computing devices 130. The computing device(s) 130 implement a security gateway 132, a web server 134, a proxy server 136, an application processing service 140, and a SMS module 142. The security gateway 132 is configured to communicate with the SCO device 110 over the network(s) 120. The web server 134 and the proxy server 136 are both connected to the network(s) 120. The web server 134 is configured to generate an apply website 138. The application processing service 140 is configured to communicate with the security gateway 132 and/or the web server 134. The SMS module 142 is configured to communicate with the application processing service 140. The SMS module 142 may be implemented by middleware. By way of a non-limiting example, the computing device(s) 130 may each be implemented as the computing device architecture 900 described below and illustrated in FIG. 9.

The authentication entity 106 operates one or more authentication computing devices 150 configured to communicate over the network(s) 120. The authentication computing device(s) 150 may implement a Uniform Resource Locator (“URL”) generator 152, a device authentication service 154, an SMS service 156, a pre-fill service 158, and/or a token service 160. By way of a non-limiting example, the authentication computing device(s) 150 may each be implemented as the computing device with architecture 900 described below and illustrated in FIG. 9.

As described herein, a user device 124 can be used in conjunction with POS device 110 to establish secure communications between user 122 and operator system 108. In some contexts, a user 122 may be concerned about privacy and communications, in particular with respect to an operator's agent that may be communicating with user 122. A user 122 can additionally have concerns about data being communicated with operator system 108 being visible to checkout agents of the operator in ways that user 122 can wish to avoid, such as the possibility of a resource request being rejected. Examples described herein use a unique URL generated by URL generate 152 of authentication entity 106 to establish secure communications between user device 124 and operator system 108 in ways that enable additional privacy and security. This also enables initiation of certain data communications using POS device 110 to allow an operator to improve sales through offers to users made through devices associated with the operator, such as POS device 110.

In various examples described herein, POS device 110 can use information from operator system 108 to identify offers available from system 104. In response to an indication of interest from a user 122 (e.g., using POS device 110), the operator computing system 108 can communicate request data to authentication entity 106. This can include identifying information from POS device 110 or user device 124 that can be used by device authentication service 154 to confirm information regarding devices related to the request data. This can include data about a location or store associated with POS device 110. This can include identifying account information, location information, or any other such context information about user device 124. The request data and information from device authentication service 154 can also provide information to other services. For example, SMS service 156 can identify whether authentication entity 106 has authorization to communicate with user device 124 in accordance with regulations limiting the ability for a business to initiate communications with user devices such as device 124. Additionally, based on other information associated with the request data, such as an expected resource request associated with the request data, pre-fill service 158 can be activated to identify or generate information for a resource request or other such information to be used in a subsequent communication from authentication entity 106 to either user device 124 or POS device 110.

Token service 160 may operate to facilitate secure communications between user 122 and various services and devices including, but not limited to, operator computing system 108 and resource issuing system 104. Additionally, token service 160 can tokenize a URL generated for user 122 by URL generator 152 in response to request data received via operator computing system 108. Tokenization is a process of substituting sensitive data elements with non-sensitive equivalents (e.g., tokens). The token is a reference identifier that can be mapped to the sensitive data via token service 160. Such a token service 160 can use large random number in combination with other systems, such as timing systems, to limit and secure the use of sensitive data being communicated over networks such as networks 120.

In some systems, information from a POS device 110 can be used by a token service 160 to generate a secure unique URL via URL generator 152 that has a use specific to operator computer system 108 or POS device 110. The secure URL may be limited for use by user 122 and/or user device 124. Additional limits can be applied to specific items 128 in association with a specific user 122 or POS device 110. For example, if request data received at authentication entity 106 includes information about an operator location for POS device 110, an object 128 at that operator location that a user 122 is considering acquiring, along with information about the user device 124 and a resource request, then a token service 160 can create a secure URL in conjunction with URL generator 152 to facilitate a resource offer specific to the location of POS device 110 and object acquisition that can only be accessed by user device 124. Additional limitations such as time limitations can be added, so that the secure URL can only be accessed via user device 124 for a limited amount of time (e.g., 10 minutes, 1 hour, 1 day, etc.). Token service 160 can be used in conjunction with other information both to allow for the generation of a tokenized URL with URL generator 152, as well as the managing of responses to the secure URL initiated from user device 124 (e.g., such as an indication that the secure URL has been accessed and a timestamp corresponding to that access, a number of instances in which the secure URL has been accessed when a time limit is exceeded, an unexpected device uses the secure URL, when other unauthorized use has been detected, etc.). Token generated by token server 160 may be also be usable to enable access to secure information. For example, a token may be generated for user 122 and/or user device 124. Requests to access secure information from an authorized device (e.g., client device 124 or POS device 110) may include an instance of the token to authenticate the request.

As described above, in some examples, authentication entity and resource issuing system 104 can, in some implementations, be the same system. In such a system, token service 160 can further act to generate tokens for resource numbers or other aspects of transactions which involve resource system 104. In additional examples, other aspects of system 100 can further be altered or include additional or intervening elements, such as multiple users, users with shared accounts, additional merchant or operator systems, subsystems that can operate independently, such as the use of an independent SMS service 156, or any other such structure for system 100.

FIG. 1B illustrates aspects of a system that can be used with custom resource allocations in according to aspects of the present disclosure. System 180 of FIG. 1B is similar to system 100 of FIG. 1, except system 180 includes a custom tender application 118 operating on POS device 190. Custom tender application 118 can be used to access elements of a resource issuing system 104, an authentication entity 106, or any other such system as part of custom tender operations outside the ecosystem of the POS device 190 in a similar manner to custom tender application 118 of FIG. 1A. Additionally implementations can include elements of custom tender application 118 operating on both a POS device such as POS device 190, as well as on a mobile device 124, or any other device including an additional third party device. In any such implementation, custom tender application 118 can be used to provide additional functionality to the POS device in a merchant system 108 environment that would not otherwise be available, including additional security that can be available through the custom tender application and associated back-end functionality described below.

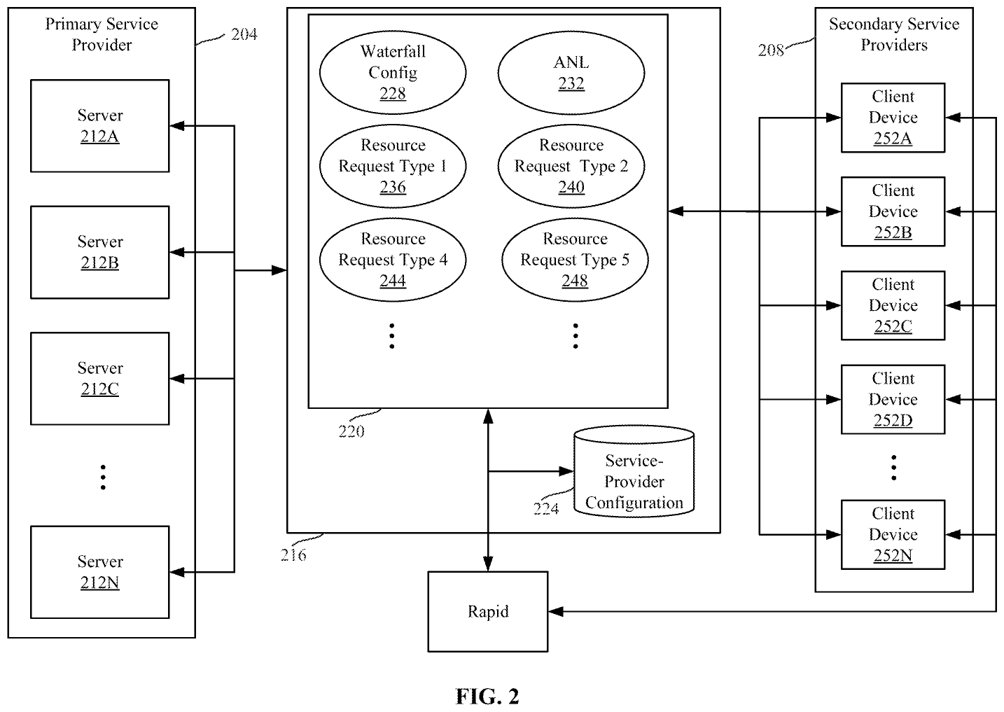

FIG. 2 illustrates an example block diagram representing a waterfall gateway according to aspects of the present disclosure. The waterfall gateway enables communications between devices of a primary service provider 204 and devices of one or more secondary service providers 208. Primary service provider may provide one or more services to users of primary service provider 208. Examples of such services provided by primary service provider include, but are not limited to, managing user accounts, resource allocation requests, resource allocations (e.g., resource issuance), object acquisitions, and/or the like. Services may be provided from one or more server devices (e.g., servers 212A-212N). Services may be provided by one or more software applications stored on and/or executed by servers 212A-212N (and/or other devices). The applications may be isolated to a single device, distributed across multiple devices and/or domains (e.g., cloud-based applications), provided as a web-service, combinations thereof, or the like. Primary service provider 204 may include any number of devices that are of a same type and/or configuration or that are of varying types and/or configurations.

Primary service provider 204 and/or the particular device 212A-212N that receives a resource request from a user may determine whether the resource request can be satisfied. For example, a user device operating within an operator may request resources for the acquisition of an object from the operator. If the resource request cannot be satisfied, the service provider(s) that received the request (e.g., primary service provider 204 and/or the particular device 212A-212N) may retransmit the user's resource request to waterfall gateway 216. Waterfall gateway 216 may include one or more device and/or service executing on the one or more devices. For example, as shown, waterfall gateway 216 includes communication manager 220 and service-provider configuration database 224. Service-provider configuration database 224 stores information associated secondary service providers (e.g., service providers 252A-252N, etc.), such as, but not limited to, an identification of the service provider, native communication protocols of the service provider, historical resource requests and/or resource allocations, a relationship (if any) between the user and the service provider, and/or the like.

Communication manager 220 manages communications between the primary service provider and the secondary service providers 208. In some instances, communication manager 220 may also manage communications between the user and primary service provider 204 and/or second service providers 208. Communication manager 220 defines the resource-request waterfall that can be transmitted to secondary service providers 208. Waterfall configuration 228 queries service-provider configuration database 224 for secondary service providers that are likely to be able to satisfy the resource request. For instance, waterfall configuration may use information associated with the resource request (e.g., amount of resources requested, types of resources requested, geographical location of the user, timestamp of the request, information associated with the user, and/or the like) to identify a set of service providers that are likely to satisfy the resource request (e.g., based on capability, historical approvals or denials of similar resource requests of other users, historical approvals or denials of resource requests involving the particular user, and/or the like).

In some instances, the selection and ordering of secondary service providers may be determined using machine-learning. For instance, the machine-learning model may be a classifier that determines a sequence of service providers using a next-best (NB) process. The NB process includes the machine-learning model first identifying a set of service providers. The set may include all possible secondary service providers 208, a predetermined quantity of secondary service provider, those secondary service providers of secondary service providers 208 that satisfy one or more criteria (e.g., being capable of satisfying a resource request of a specified size, likelihood of satisfying the resource request, geolocation of the user and/or the secondary service provider, size of the secondary service provider, and/or any other criteria), all possible servers 212A-212N (excluding the server that denied the initial resource request), a predetermined quantity of servers 212A-212N, those servers 212A-212N that satisfy one or more criteria, combinations thereof, or the like. The machine-learning model may then identify a first secondary service provider from the set of service providers that may be the most likely to satisfy the resource request (e.g., based on an output from the machine-learning model), then removes the first secondary service provider from the set of service providers. The machine-learning model then identifies the next-best secondary service provider from those service providers remaining in the set of service providers. The NB process continues until a predetermined quantity of service providers are selected or the set of service providers is empty.

The machine-learning model may be a classifier that generates a prediction of a criteria associated with a secondary service provider and the resource request such as a likelihood that the secondary service provider will satisfy the resource request. The machine-learning model may be any model configured to generate such predictions including, but not limited to, a regression (e.g., logistic etc.), a support vector machine (SVM), a decision tree classifier, a random forest classifier, Naïve Bayes (e.g., such as a Gaussian Naïve Bayes, etc.), or the like. In some instances, waterfall config 228 may determine a particular machine-learning model based on the prediction being made. For instance, a first model may have high accuracy and precision when predicting a first prediction type (e.g., such as a likelihood that the secondary service provider will satisfy the resource request), but a different model may have a higher accuracy and/or precision for a different prediction type (e.g., a likelihood that the secondary service provider is capable of satisfying a particular resource request). Waterfall gateway 216 may define and train multiple models of varying types. Waterfall config 228 may then determine a particular model to use to generate the sequence of service providers based one or more predetermined criteria of the resource request.

Waterfall config 228 may obtain information associated with the resource request, the user, and secondary service providers that may have a relationship with the user using account number lookup (ANL) 232. A resource request may include one or more user accounts established between the user and a primary service provider 204 and/or secondary service provider 208. Alternatively, waterfall gateway 216 may include a database that stores, for each user, a set of user accounts which have been established between the user and primary service providers 204 and/or secondary service providers 208. Since each service provider has its own syntax for generating user accounts, ANL 232 may store a database of user account syntaxes that correspond to servers 212A-212N and/or secondary service providers 208. Waterfall config transmit a request to ANL 232 to parse the account numbers of a resource request (or those associated with a user) and identify a server 212A-212N and/or secondary service provider 208 (e.g., client device 252A-252N) that corresponds with each user account. ANL 232 may pass an identification of servers 212A-212N and/or secondary service providers 208 that are associated with the account numbers of the resource request (or user of the user request) to waterfall config 228. Waterfall config 228 may use the identified servers 212A-212N and/or secondary service providers 208 to generate the set of service providers.

Waterfall config 228 may use resource request types 236-248 to further define the set of service providers, each resource request type may include constraints on the service provider and/or the resource allocation. As a result, the resource request type may further limit the set of service providers from which a sequence of service providers may be derived. Examples of resource request types include acquisition of an object (e.g., subject to a particular acquisition protocol), authorization for a resource allocation, resource release (e.g., a return of resources allocated by the user for acquisition of an object), forced acquisition (e.g., a forced resource allocation in exchange for one or more objects), application (e.g., an application for a resource, resource allocation, user account, or the like), or the like.

Once the sequence of service providers is established waterfall gateway 216 generates a resource-request waterfall (e.g., a sequence of transmissions, one to each service provider in the sequence of service providers). Communication manager 220 includes a set of application programming interfaces (APIs) configured to enable services associated with each service provider. When a secondary service provider registers with waterfall gateway 216, waterfall gateway 224 uses service-provider configuration 224 to generate an API for the secondary service provider. The API can be configured to translate communications of waterfall gateway 220 into a native communication protocol of the secondary service provider and/or translate communications in a native communication protocol of the secondary service provider to a communication protocol of waterfall gateway 220. For example, communications transmitted by waterfall gateway 220 can be structured according to the architecture and syntax expected by a secondary service provider to ensure that the secondary service provider can decode and parse communications from waterfall gateway 216.

In some instances, the APIs of communication manager 220 may be configured to transmit data and/or instructions through web-services of secondary service providers 208. For example, transmitting the resource request to a service provider may include navigating through one or more interfaces of a web-service configured to allocate resources. The resource request of a resource-request waterfall may be the same as if the user transmitted the resource request to the secondary service provider directly.

Once the resource-request waterfall is configured by the communication manager 220, the resource-request waterfall can be executed by waterfall gateway 216. Executing the resource-request waterfall may cause a waterfall gateway to transmit a resource request to the first service provider in the sequence of service providers. Waterfall gateway 216 may wait a predetermined time interval for a response. If the service provider approves the resource request, the resource-request waterfall may be terminated. The waterfall gateway 216 may transmit a communication to the user indicating that the resource request is approved. The communication may include information associated with the approval (e.g., an identification of the service provider, terms of the approval, a timestamp corresponding to when the resource request was approved, etc.). The service provider may request additional information from the user to facilitate the allocation of resources to the user (e.g., user device, user account, identification of an object being acquired, etc.). In some instances, waterfall gateway may transmit a link to the user to enable the user to navigate to the service provider and complete the resource allocation directly with the service provider. In other instances, waterfall gateway 216 may obtain the requested information from the service provider and request the information from the user. Waterfall gateway 216 may receive the requested information from the user and transmit the requested information to the service provider using the APIs of communication manager 220 to translate the requested information into a native communication protocol of the service provider. The requested information may include information associated with an identification of the user, resources of the user, previous resource requests, confirmation of resource allocation terms, etc. Once the requested information is received by the service provider, the service provider may allocate the requested resources to the user.

If the first service provider in the sequence of service providers denies the resource request or the predetermined time interval lapses (e.g., times-out), the resource-request waterfall continues by transmitting the resource request to the next service provider in the sequence. The resource-request waterfall continues to transmit the resource request until a service provider approves the request or there are no more service providers in the sequence of service providers.

In some examples, if the resource-request waterfall fails to satisfy a resource request (e.g., none of the service providers approve the resource request), waterfall gateway 216 may transmit a communication to the user indicating that the resource request could not be satisfied. The communication may include one or more recommendations to alter the resource request to improve the likelihood that a service provider may approve the resource request (e.g., requesting fewer resources, indicating a time interval over which the resources may be returned to the service provider, etc.). Waterfall gateway may receive a revised resource request from the user (e.g., including one or more of the recommendations and/or one or more other alterations to the original resource request) and define a new resource-request waterfall corresponding to the revised resource request. The new resource-request waterfall may include one or more of the service providers selected as previously described, which may include one or more resources providers included in the previous resource-request waterfall and/or one or more new service providers. Alternatively, if the resource request is not revised, then waterfall gateway 216 may define a new resource-request waterfall that includes new service providers (e.g., those service providers not included in the previous resource-request waterfall) or, if no such service providers exist, waterfall gateway 216 may terminate further processing of the resource request.

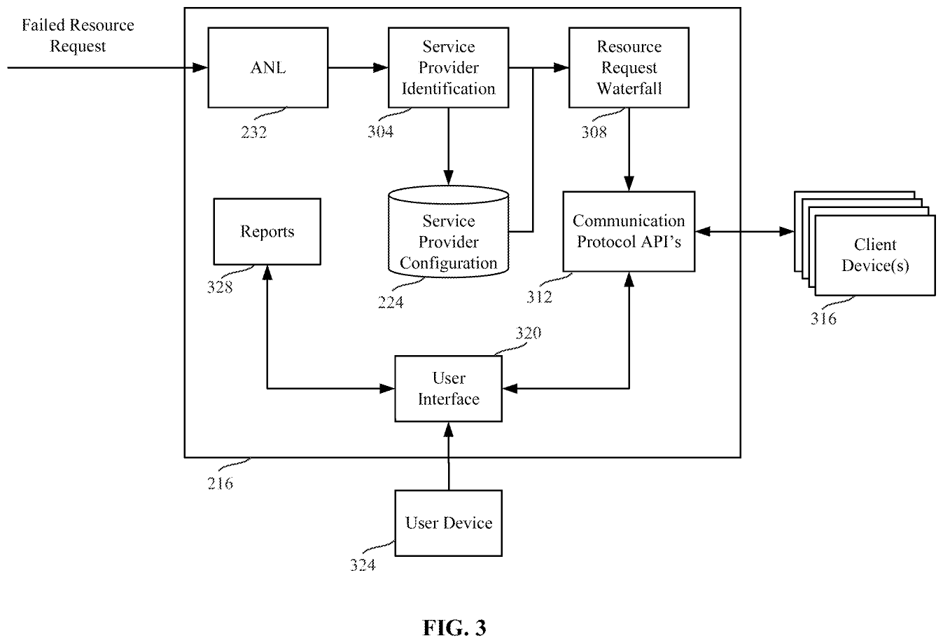

FIG. 3 illustrates an example block diagram representing the establishment of communications between a client device and a user device through a waterfall gateway according to aspects of the present disclosure. A user device may initiate a resource request to a primary service provider. If the resource request fails (e.g., the primary service provider denies the resource request), waterfall gateway 216 may establish communications between a user device (e.g., mobile device, computing device, a POS, etc.) from which a resource request was initiated, and a client device operated by a secondary service provider to enable a secondary service provider to satisfy the resource request. The waterfall gateway receives the failed resource request from the device and/or service of the primary service provider. Gateway waterfall 216 uses AN 232 to parse the failed resource request to identify information associated with the user (e.g., user identifiers, location, device identifiers, user accounts, and/or the like) and information associated with the failed resource request (e.g., resources requested, server/service of the primary service provider that caused the resource request to fail, objects requested, and/or the like). ANL 232 identifies user accounts established between the user device and the secondary service provider (e.g., using a database lookup or information in the failed resource request).

ANL 232 passes an identification of the user accounts (if any) to service-provider identification 304. Service-provider identification 304 identifies a set of secondary service providers to be included in a resource request waterfall. Service-provider identification 304 may include secondary service providers that are likely to satisfy the resource request, which may include secondary service provider identified by ANL 232 (which already has an established relationship with the user or user device) and/or secondary service providers. Service-provider identification 304 may identify secondary service providers using service-provider database 224 and/or machine-learning. For example, service-provider identification 304 may identify secondary service providers that may be capable of satisfying the resource request. In another example, a machine-learning model may be used to predict the likelihood that a secondary service provider will approve the resource request. Service-provider identification 304 may select those secondary service providers having a likelihood that is greater than a threshold.

An identification of the secondary service providers identified by service-provider identification 304 as being likely to satisfy the resource request may be passed to resource request waterfall 308. Service-provider identification 304 may also transmit a query to service-provider configuration database 224 using the identified secondary service providers. The query may request configuration information of each identified secondary service provider such as, but not limited to, an identifier of the secondary service provider, historical resource allocations between the secondary service provider and the user device (or a user thereof), historical resource allocations between the secondary service provider and other users, available resources, available services, physical locations, identification supported communication protocols, configuration of web-services, or the like. The query response including the configuration information of the secondary service providers may be passed to resource request waterfall 308 for defining a resource request waterfall. The resource-request waterfall includes a sequence of transmissions to each of the identified secondary service providers.

Resource-request waterfall 308 defines an order in which identified secondary service providers are to receive a resource request. Resource request waterfall 308 may determine the order using a next-best process (e.g., selecting a best secondary service provider followed by the next best, and so on until there are no more secondary service providers to receive the resource request). In some instances, the evaluation of each identified secondary service provider to determine the order in which the resource request is to be transmitted may be performed by a machine-learning model (e.g., a support vector machine, Naïve Bayes classifier, logistic regression, decision tree, nearest neighbor, random forest, k-means, or the like). In those instances, the machine-learning model may be trained to generate a score for each secondary service provider relative to the user device of the resource request. The score may correspond to a likelihood that the secondary-service provider may satisfy the resource request (e.g., allocate the requested resources to the user device or the user thereof), a likelihood that the secondary-service provider is capable of satisfying the resource request, or the like. Resource-request waterfall 308 may then order the secondary-service providers based on the assigned scores.

Resource request waterfall 308 may define a first transmission in the sequence using communication protocol API's. Since each secondary service provider operates a native architecture and communication protocols, each transmission may be translated, using an API, into the architecture and protocol expected by the secondary service provider. Communication protocol API's 312 include APIs for translating communications in a format of waterfall gateway 216 into a native communication protocol of a secondary service provider. Communication protocol API's 312 may also translate executable instructions and/or function calls of waterfall gateway 216 into the native architecture of the secondary service provider. A resource request may include a request for a secondary service provide to allocate resources to the user device or a user thereof and/or instructions that enable waterfall gateway 216 to control at least a portion of processing of the resource request for the secondary service provider.

In addition to processing communications to secondary service providers, communication protocol API's 312 may include API's for translating user interfaces presented to user device 324. Once a resource request is transmitted to a secondary service provider and the secondary service provider approves the resource request, the secondary service provider may request additional information and/or certifications from user device 324. In some instances, client device 316 may include web-services or other application through which the user device may provide the information and/or certifications. Since user device 324 is already connected to waterfall gateway 216 communication protocol API's 312 of waterfall gateway 216 can translate the communication protocols of secondary service providers, waterfall gateway 216 may use Communication protocol API's 312 to translate the user interfaces of the web-services and/or applications of the secondary service provider. This enables waterfall gateway 216 to present the web-services and/or applications of the secondary service provider through user interface 320 of waterfall gateway 216. User device 324 may interact with client device 316 of the secondary service provider to complete the resource request and resource allocation as if the client device was directly connected to client device 316.

Information transmitted through user interface 320 may be translated into the corresponding communication protocol native to the recipient device. For example, the additional information requested by the secondary service provider may be provided by user device 324 through user interface 320 of waterfall gateway 216. Waterfall gateway 216 may use communication protocol APIs' 312 to translate the information into the communication protocol native to the secondary service provider. The secondary service provider receives the requested information in a same way as it would if the user device interacted directly with client device 316 of the secondary service provider.

If the resource request to the first secondary resource provider fails (e.g., the secondary resource provider denies the resource request or fails to respond to the resource request within a predetermined time interval), resource-request waterfall may define a resource request transmission to the next secondary service provider of the identified secondary service providers. Resource-request waterfall 308 may continue to transmit resource requests to secondary service providers, in order, until a resource request is approved or there no more secondary service providers to receive a resource request.

Reports 328 may receive and/or derive information associated with the operation of waterfall gateway 216 such, as but not limited to, an identification of resource requests and information associated therewith, generated resource-requests, an indication of whether each resource-request waterfall terminated successfully (e.g., with an a resource request being approved by a service provider), an identification of the service provider that approved a resource request (if the resource request was approved), an identification of service providers that denied the resource request, user information (e.g., feedback associated with a resource request indicating the user's experience with the resource-request waterfall, service providers thereof, waterfall gateway 216, etc.), service provider information (e.g., feedback associated with resource requests, an indication as to why particular resource requests were approved or denied, etc.), and/or the like. Waterfall gateway 216 may generate or expose one or more graphical user interface configured to access the information of reports 328. The graphical user interface may be usable to request particular information, generate reports, etc. Alternatively, waterfall gateway 216 may expose one or more application programming interfaces that may enable programmatic and/or remote access to waterfall gateway 216 and/or reports 328.

In some examples, reports 328 may be usable to modify the operations of waterfall gateway 216. Reports 328 may include processes configured to use the historical data to detect patterns, generate predictions, and/or like. The detected patterns, generated predictions, etc. may be usable to modify operations of waterfall gateway 216 to optimize particular operations, reduce resource consumption, increase efficiency, etc. For example, reports 328 may detect that a particular service provider approves resource requests under particular conditions. Reports 328 may cause waterfall gateway 216 to select the particular service provider for inclusion in a subsequent resource-request waterfall when the resource request satisfies the detected conditions.

The processes may include algorithms, machine-learning models, and/or the like. Machine-learning models (e.g., neural networks, support vector machines, deep learning networks, classifiers, decision trees, and/or the like) may be trained to classify resource requests, identify and/or select service providers, generate resource-request waterfalls, generate predictions (e.g., such as a likelihood that a particular service provider will approve a particular resource request, etc.). Reports 328 may use the received and/or derived information to generate feature vectors that may be used to train the machine-learning models and as input to trained machine-learning models to generate particular outputs. The machine-learning models may be trained (e.g., using supervised learning, semi-supervised learning, unsupervised learning, reinforcement learning, and/or the like) over set of iterations and/or until one or more predetermined accuracy metrics are satisfied (e.g., accuracy, precision, recall, area under the curve, F1 score, mean absolute error, mean squared error, confusion matrix, etc.). Once trained, reports 328 and/or waterfall gateway 216 may execute the machine-learning models on historical data to improve subsequent operations of waterfall gateway (e.g., generating resource-request waterfalls, etc.). Alternatively, or additionally, reports 328 and/or waterfall gateway 216 may execute the machine-learning models in real time (upon receiving a resource request) execute the operations of waterfall gateway 216.

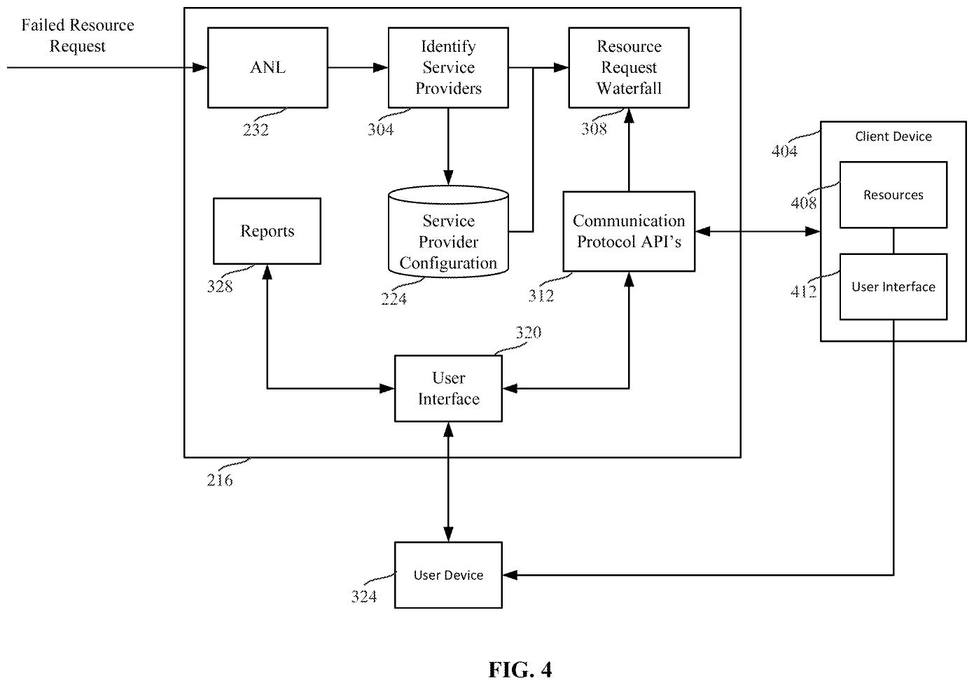

FIG. 4 illustrates an example block diagram representing a waterfall gateway that establishes communications between a client device and a user device according to aspects of the present disclosure. Waterfall gateway 216 may enable user device 324 to interact with a secondary service provider through user interface 320 of waterfall gateway (e.g., a described FIG. 3). In some instances, waterfall gateway 216 may be unable to translate user interfaces for a secondary service provider (e.g., due to network error, missing APIs, etc.). Instead, when a resource request transmitted to a secondary service provider is approved, waterfall gateway 216 may direct user device 324 to connect directly to client device 404 of the secondary service provider to complete the resource allocation. Client device 404 may generate user interfaces 412 for display by user device 324. User device 324 can complete the resource allocation by providing any additional information requested by the secondary service provider, certifications (e.g., of terms, or the like), or the like.

Once the requested resources are allocated to user device 324, user device 324 may disconnect from the secondary service provider. User device 324 may provide waterfall gateway 216 with an identification of the resources allocated (e.g., quantity of resources allocated, type of resources allocated, terms of the resource allocation, identification of a user account with the secondary service provider, etc.). Alternatively, the secondary service provider may provide the identification of the resources allocated to waterfall gateway 216.

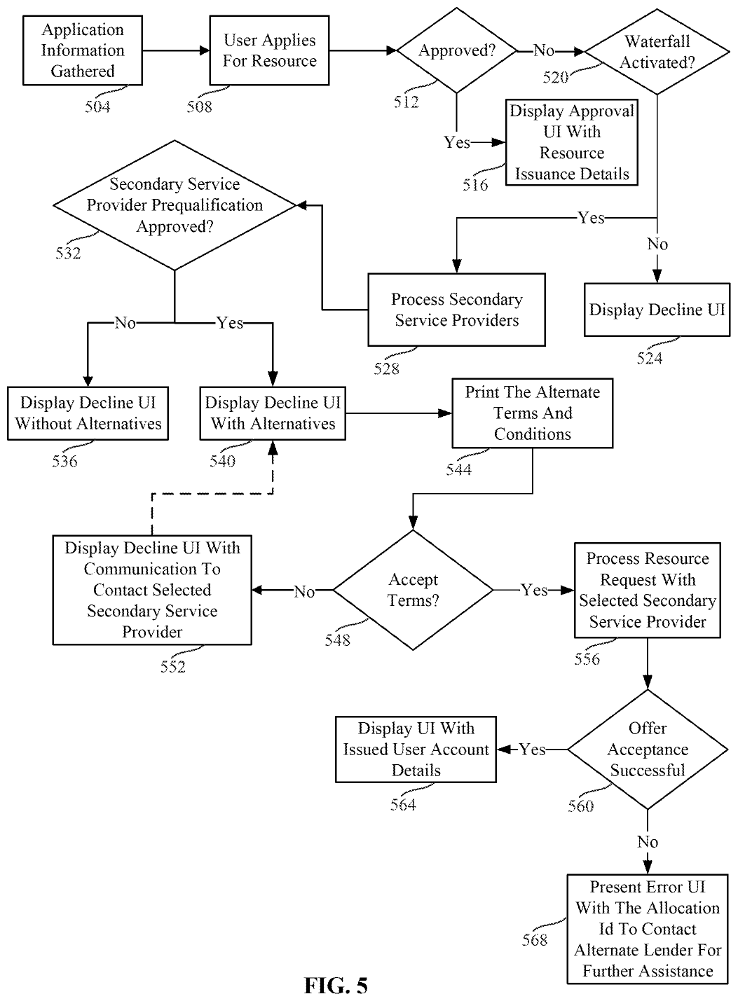

FIG. 5 illustrates a flowchart of an example execution of a communication process that includes a waterfall gateway according to aspects of the present disclosure. The communication process may be executed by one or more devices including devices of a primary service provider, devices of a secondary service provider, and/or a waterfall gateway. The waterfall gateway may be a system of one or more computing devices or software executing on one or more computing devices. In some instances, the waterfall gateway may be, or be executed by, a device of the primary service provider. In other instances, the waterfall gateway may be separate system from the devices of the primary service provider. In the ensuing description of FIG. 5, it may be indicated that a particular block is executed by a device of the primary service provider, the waterfall gateway, or the secondary service provider. However, each service provider and the waterfall gateway can maintain APIs that translate commands and communications into native architectures and protocols of a receiving device. As such, each block may be executed by any particular device (e.g., devices of the primary service provider, devices of a secondary service provider, and/or the waterfall gateway).

The communication process may begin at block 504 when a user device generates a request for resources. The user device (e.g., computing device, mobile device, POS device, etc.) may be located within an operator (or connected to a website or web-service of the operator) and requesting resources in the acquisition of an object from the operator. The user may provide information identifying the resources requested (e.g., type, quantity, etc.), identifying the object(s) or service(s) to be acquired, identifying the user device (e.g., a user identifier, hash token assigned to the user or user device, geolocation of the user device, hardware configuration information such as a hardware fingerprint of the user device, combinations thereof, or the like).

At block 508, the resource request may be transmitted to a device operated by a primary service provider. The user may transmit the resource request through a web interface (e.g., Hypertext Transfer Protocol Secure, or the like), a web-service, an application of the user device and/or device operated by the primary service provider, or other secure communication protocol. In some instances, the request may be transmitted to a particular service of the primary service provider. The resource may request may correspond to a resource associated with an operator that may be managed by the primary service provider.

At block 512, the primary service provider determines whether to approve or deny the resource request.

At block 516, which occurs when the resource request is approved, a user interface is displayed on the user device indicating the resource request was approved. The user interface may also include an identification of resource issuance details (e.g., user account information established by the primary service provider for the resource request, etc.), information regarding the primary service provider and/or the particular service of the primary service provider that approved the resource request, and/or the like.

At block 520, which occurs when the resource fails (e.g., the service of the primary service provider denies the resource request, the resource request times out without a response from the primary service provider, communication error, network error, execution error, etc.), it is determined whether the waterfall is activated. When the waterfall is activated, denied resource requests may be passed through the waterfall gateway to a sequence of secondary service providers that may satisfy the resource request. The waterfall gateway transmits the resource request to a first secondary service provider, if the resource request fails, the waterfall gateway transmits the resource request to the next secondary service provider in the sequence. With waterfall activated, the waterfall gateway can ensure that resource requests are satisfied even when the primary service provider fails to approve or allocated the requested resources.

At block 524, which occurs when waterfall is not activated, a user interface is displayed by the user device indicating that the resource request failed. The waterfall gateway may enable or disable waterfall based on the failed resource request, a communication from the primary service provider, a communication from the user device, a communication from a secondary service provider, an insufficient quantity of secondary service providers to receive the failed resource request, errors (e.g., such as a communication or network error, unhandled exceptions, processor interrupt, insufficient processing resources, etc.), and/or the like. Secondary service providers may determine to be included in a waterfall or not, if a secondary service providers determines not to be included in a waterfall, then the secondary service provider may not be included in the sequence of service providers generated by the waterfall gateway.

Since waterfall is disabled, the communication process cannot continue to identify an alternative device to satisfy the resource request of the user device. As a result, the communication process may terminate. Alternatively, the communication process may return to block 504 and request that the user device transmit a new resource request to the primary service provider. In another alternative, the waterfall gateway may identify a single alternative service provider (e.g., a secondary service provider) that may satisfy the resource request. Since waterfall is disabled, the waterfall gateway may not identify a sequence of secondary service providers to ensure that a secondary service provider will satisfy the resource request. The waterfall gateway may still identify one other secondary service provider that may satisfy the resource request.

At block 528, which occurs when waterfall is activated, the waterfall gateway processes the set of secondary service providers that may be likely to satisfy the resource request. The waterfall gateway may also generate a sequence of secondary service providers from the set of secondary service providers that includes order from most likely to satisfy the resource request to least likely. Processing the secondary service providers may include identifying a configuration of the secondary service provider, identify a relationship (if any) between the secondary service provider and the user device, identifying historical resource request transmitted to the secondary service provider, identifying historical resource allocations executed by the secondary service provider, and/or the like. The information may be obtained from a database (e.g., stored from a previous execution of the waterfall) or from a device of the secondary service provider.

At block 532, the waterfall gateway determines if the user device is preauthorized for the resource allocation based on constraints of secondary service providers of the sequence of secondary service providers (e.g., based on the information obtained from block 528 and from block 504).

At block 536, which occurs when the waterfall gateway determines that the user device is not preauthorized for the resource allocation, the a user interface is displayed on the user device indicating that the resource request failed and the communication process is terminated without presenting the user device with the secondary service provider. Alternatively, the communication process may return to block 504 and request that the user device transmit a new resource request to the primary service provider.

At block 540, which occurs when the waterfall gateway determines that the user device is preauthorized for the resource allocation, a user interface is displayed on the user device that provides an identification of the sequence of secondary service providers (e.g., the resource request waterfall). In some instances, the user interface displays a first secondary service provider in the sequence. In other instances, the user interface displays each secondary service provider in the sequence. The order in which the secondary service providers are displayed may be based on the sequence. Alternatively, the order may be based on criteria of the user device, alphabetical order, terms and conditions of the secondary service providers, likelihood of satisfying the resource request, or the like.

At block 544, the terms and conditions of a selected secondary service provider may be presented (e.g., printed, displayed on the user interface, transmitted to another device associated with the user device, through a web interface, or the like). The selected secondary service provider may be the first service provider in the sequence. Alternatively, the selected secondary service provider may be selected by the user device, waterfall gateway, primary service provider, based on a criteria of the secondary service provider, machine-learning model, likelihood that the secondary service provider will approve the resource request, or the like.

At block 548, it is determined whether approval of the terms and conditions is received from the user device.

At block 552, which occurs when approval is not received (or disapproval is received), at user interface is displayed by the user device that indicates that the terms are were not approved (or were disapproved) by the user device. The user interface may direct the user device to establish a direct connection with the selected secondary service provider to determine alternate terms for the resource request. In some instances, the waterfall gateway may facilitate the connection with the selected secondary service provider. For instance, the waterfall gateway may use API's to translate the interfaces of the selected secondary service provider and/or communication protocols of the secondary service provider to enable the waterfall gateway to manage the communications between the user device and the selected secondary service provider. The communications by the user device may be improved as the user device need not identify the native interfaces and/or protocols of the secondary service provider to enable such direct communications.

If the selected secondary service provider fails to allocate the requested resources, the communication process may revert to block 540 in which a new secondary service provider may be selected. The new secondary service provider may be the next service provider in the sequence of secondary service providers (e.g., of the resource request waterfall). Alternatively, the selected secondary service provider may be selected by the user device, waterfall gateway, primary service provider, based on a criteria of the secondary service provider, machine-learning model, likelihood that the secondary service provider will approve the resource request, or the like. The process may then continue to block 544.

If the selected secondary service provider fails to allocate the requested resources and there are no other secondary service providers in the sequence (or the user device declines to proceed with the resource request waterfall), the communications process may terminate.

At block 556, which occurs when the user device approves the terms of the selected secondary service provider, the resource request is processed (e.g., by the secondary service provider and/or the primary service provider).

At block 560, it is determined wither the resource allocation was successful.

At block 564, which occurs when the resources were allocated successfully, a user interface is displayed on the user device indicating details of the resource allocation. For example, the user interface may display user account information indicating the relationship between the user device and the selected secondary service provider, the quantity of resources allocated, indication as to how or when the resources are to be returned to the secondary service provider, etc. With the resource request and resource allocation satisfied, the communication process may terminate.

At block 568, which occurs when the resource allocation fails (e.g., which may be caused by the user device, the primary service provider, selected secondary service provider, communication error, network error, software or hardware error, etc.), a user interface may be displayed by the user device indicating the resource allocation failed, along with a resource allocation identifier. The user interface may also direct the user device to connect directly with the selected secondary service provider to correct the error that caused the resource allocation to fail. As similarly described in block 552, the waterfall gateway may manage the communications between the user device and the selected secondary service provider, or the user device may directly connect to the selected secondary service provider (e.g., excluding the primary service provider and/or waterfall gateway) from the transmission path.

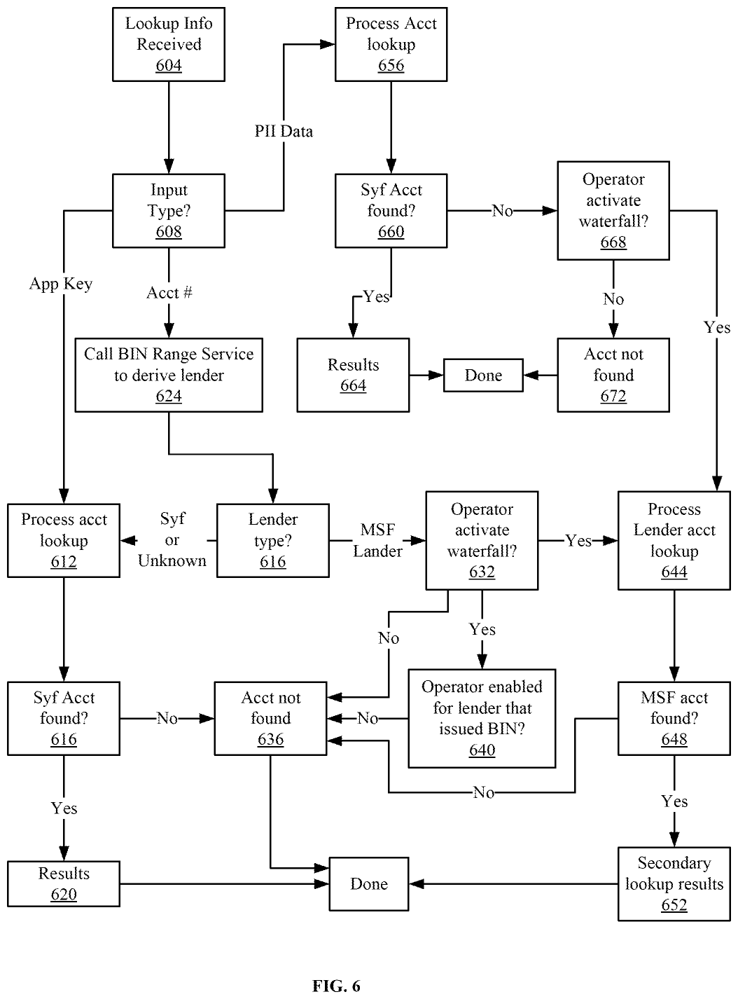

FIG. 6 illustrates a flowchart of an example account lookup process executing within the waterfall gateway according to aspects of the present disclosure. At block 604, the process begins when lookup information is received. The information may include user identifying information (e.g., user identifier, globally unique identifier, a hash identifier, name, geolocation, user device identifiers, etc.), user account identifiers, identification of a service provider associated with the user, application keys, or the like.

At block 608, the lookup information is parsed according to the type information included in the lookup information. The lookup information can include any quantity or type of information. The lookup information may be parsed by a numerical analyzer, lexical analyzer, or the like to translate the lookup into a set of discrete tokens. Each of one or more subsets of the tokens may be used to identify a user account associated with the lookup information.

At block 612, the tokens that correspond to application keys may be processed by a primary service provider. The application keys may be issued by a service (e.g., application, etc.) of the primary service provider to the user to enable secure communications between a user device and the service. The primary service provider may identify the account that correspond to the application keys.

If the user account is identified by the primary service provider (as determined at block 616), at block 620 a user interface can be displayed presenting information associated with the user account (e.g., user account number, resources allocated to the user device, terms, etc.).

If the user account is not identified (at block 616), then the process continues to block 636 where it is determined that the user account could not be identified and the process terminates or, alternatively, returns to block 604. In some instances, the user device or the primary service provider may display a user interface indicating that the user account could not be identified (e.g., account lookup failed).

At block 624, when the tokens correspond to a user account number (as determined at block 608), a BIN Range service may be called using the user account number. The Bin Range service may analyze the user account number to determine if the sequence, structure, length, or a combination thereof, conforms to a sequence, structure, length, or a combination thereof of a service of the primary service provider or of a secondary service provider. The BIN Range service may then identify a type of secondary service provider associated with the account number.

If the secondary service provider type is not identified (as determined at block 628), the process proceeds to block 612, where the primary service provider attempts to identify the user account from the user account number.

At block 632, if the secondary service provider type is identified (as determined at block 628), then the primary service provider determines if waterfall is enabled by the secondary service provider (or an operator associated with the secondary service provider) identified by the secondary service provider type. If waterfall is disabled, then the process continues to block 636 as previously described.

At block 640, which occurs when waterfall is activated (as determined at block 632), it is determined whether an operator is enabled by the secondary service provider that issued the user account. If the operator is disabled (or otherwise not enabled), the process continues to block 636 as previously described.

At block 644, when the operator is determined to be enabled at block 640, the secondary service provider user account look is processed. Since the BIN Range service identified the secondary service provider type associated with the user account, the secondary service provides that correspond to the secondary service provider type may be queried using the user account number to determine the secondary service provider that established the user account.

At block 648, it is determined whether the user account was identified (at block 644). If the user account is not identified, the process returns to block 636 as previously described.

At block 652, when it the user account is identified, a user interface is displayed by the primary service provider, secondary service provider that established the user account, or the user device with the results from the query at block 644. In some instances, only one user account may be identified. The user device may then obtain information associated with the user account as described in connection to block 620. In other instances, the results may include one or more user accounts that correspond to the user account number provided by the user device. Since the user account may include a structure that is used by multiple secondary service providers, the query 644 may identify multiple user accounts. The user interface may display details of each user account enabling the user device to select the user account that corresponds to the lookup information. The details may obscure some information associated with each account to prevent a display of personal identifiable information (PII) or other sensitive information associated with other users (e.g., not the user of the user device).

If the tokens correspond to user information (e.g., PII) at block 608, the process continues to block 656, where the primary service provider uses the PII to identify the user account.

If the account is identified (at block 656 and 660), then the process presents a user interface with the account details as similarly described at block 620.

At block 668, it is determined if an operator has waterfall enabled. If waterfall is enabled by the operator, the process continues to block 644 as previously described.

At block 672, which occurs when waterfall is not enabled by the operator (at block 668), it is determined that the user account could not be identified. In some instances, a user interface may be displayed by the user device or the primary service provider indicating that the user account could not be identified (e.g., account lookup failed). The process then terminates or, alternatively, returns to block 604.

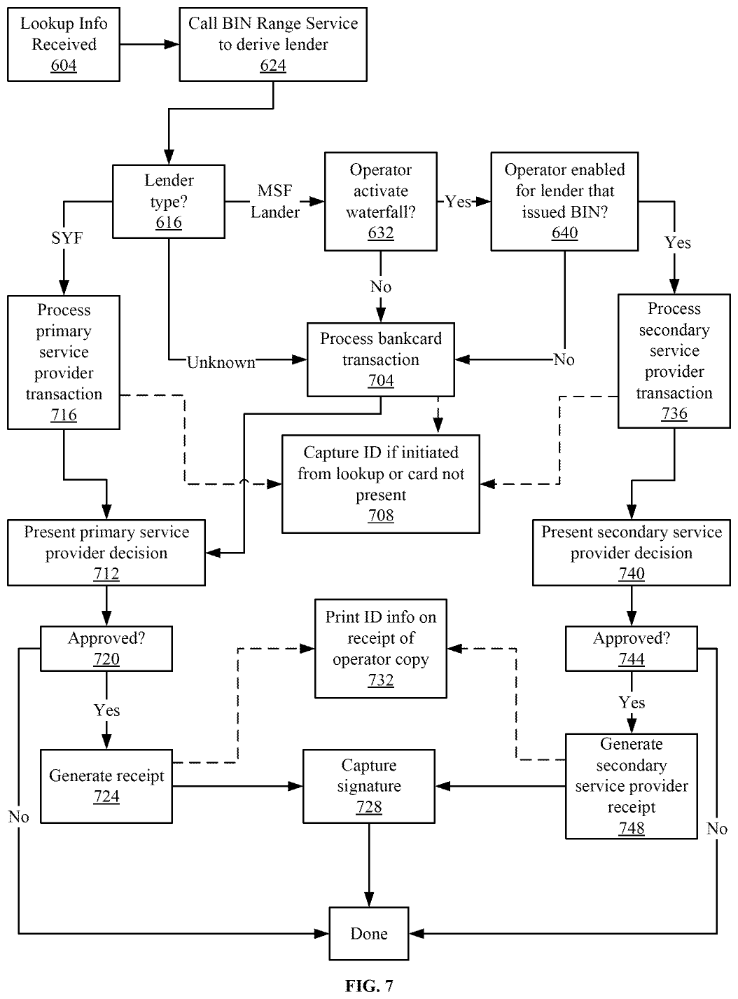

FIG. 7 illustrates a flowchart of an example object acquisition process executing within the waterfall gateway according to aspects of the present disclosure. A request may be received from a user device for access to a resource, a resource allocation request, object acquisition from an operator, or the like. The process of FIG. 7 may then begin by performing a user account look up as similarly described in connection to FIG. 6. Lookup information may be received at block 604 and a BIN Range service may be called at block 624 to identify the service provider and/or service provider type (as previously described).

If, at block 628, the BIN Range service indicates that the lookup information corresponds to a secondary service provider, then the process continues by determining if the operator has waterfall enabled (at block 632) and if so whether the operator enabled the secondary service provider that established the user account identified by the BIN Range service at 640.

If the service provider (at block 628) is unknown, or if the operator does not have waterfall enabled (at block 632), or if the operator did not enable the secondary service provider that established the user account identified by the BIN Range service, then the process continues to block 704 where the primary service provider may manage the request using an allocated resource card (e.g., a bankcard, or the like).

In some instances, the process may include block 708, when a user identifier or user account information is missing. In those instances, the service provider managing the request may request the missing information from the user device.

At block 712, the primary service provider presents a user interface indicating an identification of a service provider (e.g., the primary service provider, a secondary service provider, etc.) that will process the resource request.

If at block 628, it is determined that lookup information corresponds to a particular service of the primary service provider, then the process continues to block 716, the primary service provider manages the resource request. The process then continues to block 712.

If it is determined, by the primary service provider that the resource request is approved (at block 720), then the primary service provider may allocate resources enabling to the operator enabling acquisition of the object or service by the user or user device. The process then continues to block 724, where the primary service provider generates a receipt.

At block 728, an approval token (e.g., such as a signature) is received from the user device or from a POS device of the operator that indicates approval of the acquisition of the object or service by the user.

In some instances, the process may include block 732, where additional information associated with the user device, the user, and/or the user request may be embedded into the receipt.

If it is determined, by the primary service provider that the user device request is not approved (at block 720), then the process terminates.

If the operator enabled the secondary service provider that established the user account identified by the BIN Range service (determined at block 640), then the process continues to block 736 where the secondary service provider processes the user request.

In some instances, the secondary service provider may lack data to process the user request. At block 708, the secondary service provider may transmit a request to the user device requesting the missing data (as previously described).

At block 740, the primary service provider may generate user interfaces enabling the user device to interact with the secondary service provider. For example, the primary service provider may receive information regarding the processing of the user request by the secondary service provider (such as a decision regarding resource approval, requests for data, etc.) The primary service provider may then generate a user interface presenting that information for the user device. The user device may interact with the secondary service provider using the interfaces generated by the primary service provider. In some instances, the interfaces may ensure that the user device remains connected to a device of the primary service provider rather than connecting directly to the secondary service provider.

At block 748, after it is determined that the user request is approved (at block 744), the secondary service provider may allocate resources to the operator enabling acquisition of the object or service by the user or user device. The process then continues to block 748, where a secondary service provider receipt is generated.

At block 728, an approval token is received from the user device or from a POS device of the operator that indicates approval of the acquisition of the object or service by the user.

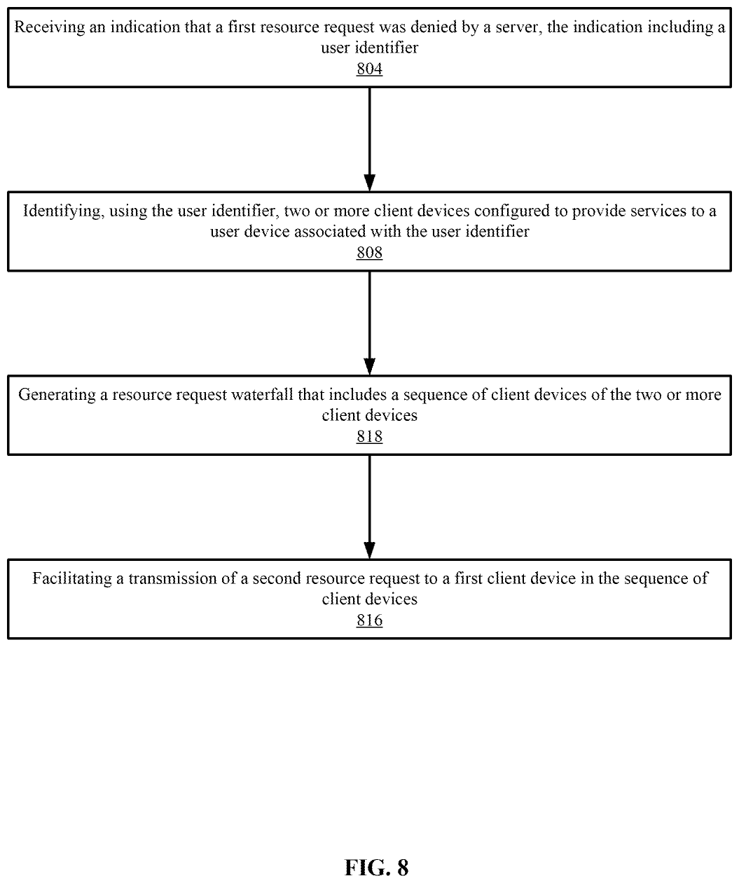

FIG. 8 illustrates flowchart of an example execution of the waterfall gateway according to aspects of the present disclosure. At block 804, the waterfall gateway receives an indication that a first resource request was denied by a device of a first service provider. The indication may be transmitted to the waterfall gateway in a representational state transfer (RESTful) protocol. The device may be a device operating a service (e.g., web-service, application, etc.) of the first service provider. The indication may include information associated with the failed resource request such an identifier of the user device that requested the resource request, an identification of the resources requested, purpose for the requested resources (e.g., object/service acquisition, etc.), an identification of the quantity of resources requested, combinations thereof, or the like.

At block 808, the waterfall gateway identifies two or more client devices configured to provide services to a user device associated with the user identifier. Each client device may be operated by a secondary service provider that allocates resources to user devices. The waterfall gateway identifies client devices that are likely to approve the resource request that previously failed. The two or more client device may be selected based on a set of criteria that include, but are not limited to, a likelihood that a client device or the secondary service provider that operates the client device is likely to approve the resource request, a quantity of resources requested, a quantity of resources available to the client device, information associated with the user and/or user device, or any other factor associated with the user device or secondary service provider. In some instances, the waterfall gateway may first determine if a client device and/or the secondary service provider operating the client device activated waterfall services (e.g., approved being included in a resource request waterfall). The waterfall gateway may then identify those client devices that have activated waterfall services and/or those client devices that meet the previously described criteria.

In some instances, the waterfall gateway may use machine-learning to identify client devices and/or secondary service providers. A machine-learning model may be trained using historical resource request waterfalls, historical resource allocations by the primary service provider or a device thereof, resource allocations by a secondary service provider or a device thereof, failed resource requests, and/or the like. Once trained, the machine-learning model may generate a prediction of a likelihood that a secondary service provider will approve the resource request and allocate the requested resources. If the likelihood is greater than a threshold, then the secondary service provider may be selected for inclusion into the resource request waterfall. The machine-learning model may be a classifier such as, but not limited to, a support vector machine, logistic regression, decision tree, Naïve Bayes, random forest, k-means, nearest neighbor, or the like.

At block 812, the waterfall gateway defines a resource request waterfall. The resource request waterfall includes an identification of a sequence of secondary service providers. Resource request transmissions may be defined for each secondary service provider in the sequence. The resource request transmission may be a version of the resource request transmitted from the user device to the primary service provider that failed. The version may be the same resource request, a similar resource request, a different resource request, or the like. For example, a device of the primary service provider that caused the initial resource request to fail may forward the resource request to the waterfall gateway. In that example, the resource request transmission may include a same resource request as initially transmitted to the device of the primary service provider.

The sequence may be defined based one or more criteria of the resource request and/or the secondary service providers. Examples of the criteria include, whether there is an established relationship with the user device, the likelihood that a secondary service provider will approve the resource request, a quantity of resources requested, an ability of the secondary service provider to satisfy the resource request, a geolocation of the user device and/or the secondary service provider, combinations thereof, or the like. In some instances, the machine-learning model may be used to define the sequence of secondary service providers. In those instances, the machine-learning model may generate a rank of each secondary service provider and order the secondary service providers according the rank. The rank may correspond to the predicted likelihood that the secondary service provider will satisfy the resource request.

The waterfall gateway may generate each resource request transmission to be in a protocol that is native to the receiving secondary service provider or a device thereof. Secondary service providers may have a proprietary architecture and/or communication interfaces. Secondary service providers may also use proprietary communication protocols. The waterfall gateway may include interfaces such as APIs configured to translate commands, function calls, and/or communications in a RESTful communication protocol into a communication protocol that is native to the receiving device of the secondary service provider. The resource request gateway, using the resource request waterfall, can generate communications that transmit the resource request to the sequence of secondary service providers enabling the user device to generate a single resource request that can be retransmitted to the propriety interfaces and protocols of multiple secondary service providers.

When a new secondary service provider registers with the waterfall gateway, the secondary service provider identifies the architectures, interfaces, and/or protocols usable to communicate with the secondary service provider. The waterfall gateway determines if there is a current interface that is configured to translate commands, function calls, and/or communications into the architecture and/or protocols native to the new secondary service provider. If the waterfall gateway does have such an interface, the waterfall gateway adapts the interface to the new secondary service protocol and stores the association between the adapted interface and the new secondary service provider. The waterfall gateway then adds the secondary service provider to a set of secondary service providers from which secondary service providers may be selected for inclusion in the sequence of secondary service providers. If the waterfall gateway does not have an interface, the waterfall gateway may either generate one using interfaces that the waterfall gateway does have, obtain one from a remote source such as a database of interface or a server, or obtain the interface from the new secondary service. The new interface may then be stored in association with the new service provider to enable future commands, function calls, and/or communications to be translated into the native architecture and/or protocol of the new secondary service provider.

At block 816, the waterfall gateway facilitates a transmission of a second resource request to a first client device in the sequence of client devices. When the resource request waterfall executes, the waterfall gateway transmits the resource request transmission to a device of the first secondary service provider in the sequence and waits for a response. If the response is an approval of the resource request, then the resource request waterfall terminates. If the resource request transmission fails (e.g., the response is a disapproval or there is no response with a predetermined time interval), then the waterfall gateway transmits the net resource request transmission that corresponds to the next secondary service provider in the sequence.

FIG. 9 shows a computing system architecture including various components in electrical communication with each other using a connection in accordance with various examples. FIG. 9 illustrates a computing system architecture 900 including various components in electrical communication with each other using a connection 906, such as a bus, in accordance with some implementations. Example system architecture 900 includes a processing unit (CPU or processor) 904 and a system connection 906 that couples various system components including the system memory 920, such as ROM 918 and RAM 916, to the processor 904. The system architecture 900 can include a cache 902 of high-speed memory connected directly with, in close proximity to, or integrated as part of the processor 904. The system architecture 900 can copy data from the memory 920 and/or the storage device 908 to the cache 902 for quick access by the processor 904. In this way, the cache can provide a performance boost that avoids processor 904 delays while waiting for data. These and other modules can control or be configured to control the processor 904 to perform various actions.

Other system memory 920 may be available for use as well. The memory 920 can include multiple different types of memory with different performance characteristics. The processor 904 can include any general purpose processor and a hardware or software service, such as service 1 910, service 2 912, and service 3 914 stored in storage device 908, configured to control the processor 904 as well as a special-purpose processor where software instructions are incorporated into the actual processor design. The processor 904 may be a completely self-contained computing system, containing multiple cores or processors, a bus, memory controller, cache, etc. A multi-core processor may be symmetric or asymmetric.

To enable user interaction with the computing system architecture 900, an input device 922 can represent any number of input mechanisms, such as a microphone for speech, a touch-sensitive screen for gesture or graphical input, keyboard, mouse, motion input, speech and so forth. An output device 924 can also be one or more of a number of output mechanisms known to those of skill in the art. In some instances, multimodal systems can enable a user to provide multiple types of input to communicate with the computing system architecture 900. The communications interface 926 can generally govern and manage the user input and system output. There is no restriction on operating on any particular hardware arrangement and therefore the basic features here may easily be substituted for improved hardware or firmware arrangements as they are developed.

Storage device 908 is a non-volatile memory and can be a hard disk or other types of computer readable media which can store data that are accessible by a computer, such as magnetic cassettes, flash memory cards, solid state memory devices, digital versatile disks, cartridges, RAMs 916, ROM 918, and hybrids thereof.

The storage device 908 can include services 910, 912, 914 for controlling the processor 904. Other hardware or software modules are contemplated. The storage device 908 can be connected to the system connection 906. In one aspect, a hardware module that performs a particular function can include the software component stored in a computer-readable medium in connection with the necessary hardware components, such as the processor 904, connection 906, output device 924, and so forth, to carry out the function.

The disclosed waterfall gateway system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor. The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the terms “computer readable medium”, “computer readable storage medium”, “machine-readable medium” and “machine-readable storage medium” should be taken to include a single medium or multiple media (e.g., a centralized or distributed database, and/or associated caches and servers) that store the one or more sets of instructions. The terms “computer readable medium”, “computer readable storage medium”, “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included (e.g., in FIGS. 6-8). A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method comprising:
receiving an indication that a first resource request was denied by a server, the indication including a user identifier;
identifying, using the user identifier, two or more client devices configured to provide services to the user;
generating a resource request waterfall that includes a sequence of client devices of the two or more client devices, wherein the resource request waterfall is configured to facilitate resource request transmissions to the one or more client devices according to the sequence of client devices; and
facilitating a transmission of a second resource request to a first client device in the sequence of client devices.

2. The method of claim 1, wherein the indication that the first resource was denied is received using a representational state transfer interface.

3. The method of claim 1, wherein the second resource request is transmitted to the first client device using a protocol that is native to the first client device.

4. The method of claim 1, further comprising:
receiving, in response to transmitting the first resource request, an indication that the second resource request was denied by the first client device; and
transmitting a third resource request to a next client device in the sequence of client devices.

5. The method of claim 1, further comprising:
receiving, in response to transmitting the first resource request, an indication of a resource allocation; and
terminating, in response to receiving the indication of the resource allocation, the resource request waterfall.

6. The method of claim 1, further comprising:
receiving, from a new client device, a request to be added to a set of service providers; and
modifying an application programming interface to translate representational state transfer communications into a corresponding communication in a protocol that is native to the new client device.

7. The method of claim 1, further comprising:
determining a resource request type associated with the first resource request;
generating a set of client devices using the user identifier and the resource request type; and
selecting the two or more client devices from the set of client devices.

8. A system comprising
one or more processors; and
a non-transitory computer-readable medium storing instructions that when executed by the one or more processors, cause the one or more processors to perform operations including:
receiving an indication that a first resource request was denied by a server, the indication including a user identifier;
identifying, using the user identifier, two or more client devices configured to provide services to the user;
generating a resource request waterfall that includes a sequence of client devices of the two or more client devices, wherein the resource request waterfall is configured to facilitate resource request transmissions to the one or more client devices according to the sequence of client devices; and
facilitating a transmission of a second resource request to a first client device in the sequence of client devices.

9. The system of claim 8, wherein the indication that the first resource was denied is received using a representational state transfer interface.

10. The system of claim 8, wherein the second resource request is transmitted to the first client device using a protocol that is native to the first client device.

11. The system of claim 8, wherein the operations further include:
receiving, in response to transmitting the first resource request, an indication that the second resource request was denied by the first client device; and
transmitting a third resource request to a next client device in the sequence of client devices.

12. The system of claim 8, wherein the operations further include:
receiving, in response to transmitting the first resource request, an indication of a resource allocation; and
terminating, in response to receiving the indication of the resource allocation, the resource request waterfall.

13. The system of claim 8, wherein the operations further include:
receiving, from a new client device, a request to be added to a set of service providers; and
modifying an application programming interface to translate representational state transfer communications into a corresponding communication in a protocol that is native to the new client device.

14. The system of claim 8, wherein the operations further include:
determining a resource request type associated with the first resource request;
generating a set of client devices using the user identifier and the resource request type; and
selecting the two or more client devices from the set of client devices.

15. A non-transitory computer-readable medium storing instructions that when executed by one or more processors, cause the one or more processors to perform operations including:
receiving an indication that a first resource request was denied by a server, the indication including a user identifier;
identifying, using the user identifier, two or more client devices configured to provide services to the user;
generating a resource request waterfall that includes a sequence of client devices of the two or more client devices, wherein the resource request waterfall is configured to facilitate resource request transmissions to the one or more client devices according to the sequence of client devices; and
facilitating a transmission of a second resource request to a first client device in the sequence of client devices.

16. The non-transitory computer-readable medium of claim 15, wherein the indication that the first resource was denied is received using a representational state transfer interface.

17. The non-transitory computer-readable medium of claim 15, wherein the second resource request is transmitted to the first client device using a protocol that is native to the first client device.

18. The non-transitory computer-readable medium of claim 15, wherein the operations further include:
receiving, in response to transmitting the first resource request, an indication that the second resource request was denied by the first client device; and
transmitting a third resource request to a next client device in the sequence of client devices.

19. The non-transitory computer-readable medium of claim 15, wherein the operations further include:
receiving, in response to transmitting the first resource request, an indication of a resource allocation; and
terminating, in response to receiving the indication of the resource allocation, the resource request waterfall.

20. The non-transitory computer-readable medium of claim 15, wherein the operations further include:
receiving, from a new client device, a request to be added to a set of service providers; and
modifying an application programming interface to translate representational state transfer communications into a corresponding communication in a protocol that is native to the new client device.
